(19) United States
(12) Patent Application Publication
(10) Pub. No.: US 2005/0008816 A1
(43) Pub. Date: Jan. 13, 2005

(54) Roll of paperband

(76) Inventors: Peter A. Rodriguez, Jacksonville, FL (US); Floyd M. Lockamy, Jacksonville, FL (US)

Correspondence Address: Arthur G. Yeager, P.A., Suite 1, 245 East Adams Street, Jacksonville, FL, 32202-3336, US

(21) Appl. No.: 10/617,418

(22) Filed: Jul. 11, 2003

(51) Int. Cl. B32B 5/00

(52) U.S. Cl. 428/98

(57) ABSTRACT

Paperband for use in paper web cutting and turn-up systems or in bailing operations includes a core of one or more elongate elements having a plurality of long creases with air spaces disposed throughout and providing non-uniform and non-planar outer surfaces. A long covering member has a smooth outer surface folded about the core and overlapping side edge portions adhesively attached together and to the core. The cover may include thin and pliable outer edge portions extending substantially equidistant laterally inwardly or the core may be scored or perforated before being wrapped by the cover member. The core may be formed of one or more elements that have been shredded into ribbons and adhesively attached to each other and to the cover. The outer edge portions are readily bendable upwardly and downwardly to release from a slotted track of a turn-up system. The outer edge portions may include a plurality of creases extending laterally thereacross to provide a serrated surface to enhance cutting by the band. The band may be thicker along its long axis. The band may be coated on one or both sides with water-soluble adhesive, which may be reactivated by moisture and/or heat.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a roll of paperband including a core formed from at least one element having a non-uniform and non-planar outer surface and a covering member about the core.

2. Prior Art

It is common practice in the papermaking and packaging industries to employ a paperband or strap that is loaded into a channel of a track assembly and then removed rapidly out of the channel and employed to cut and spool a web of paper onto an empty spool or to be used to wrap around and secure a load, container or a bundle of material. Because the paperband should be stiff enough to be pushed into the channel from one end thereof, the band may twist or otherwise be distorted or separated during upward movement that is accomplished by a “stripping” action during removal from the paperband track assembly. This becomes a very important consideration in those applications where the width of the channel opening is made less than the width of the band or tape and the lower tape-carrying guide way of the channel in order to cover and carry the tape. An improved paperband is disclosed herein that greatly reduces the distortion and crimping common to prior art paperbands, reduces the wear on the guide way channel and its cover, and also reduces the separation of layers in bands made from multiple layers and from yarns formed side-by-side into a cutting or banding tape.

### BRIEF SUMMARY OF THE INVENTION

In view of the foregoing background, it is therefore an object of the invention to provide a roll of paperband that overcomes the above-noted shortcomings. These and other objects, features, and advantages of the invention, are provided by a paperband for use in paper web cutting and turn-up systems or for use in bailing wherein an elongate core includes an elongate element having a longitudinal axis with a plurality of longitudinal creases disposed throughout to form the core with a non-uniform and non-planar outer surface. An elongate covering member is folded about the core, and includes a generally smooth outer surface extending along the core and having a central long axis and side edge portions spaced from and substantially parallel to the central axis with one side edge portion overlapping another side edge portion and adhesively attached to each other and the core is adhesively attached to the covering member.

Other aspects are seen in the plurality of longitudinal creases defining a plurality of randomly non-uniform fold angles relative to a plane of the core, and providing differing spatial dimensions therebetween. The element and covering member are deformable to permit formation into predetermined shapes particularly having a generally rectangular cross-sectional shape. Further, at least another element, being substantially a similar element, which is disposed side-by-side and substantially parallel to each other along longitudinal axes. The paperband has elongate outer edge portions spaced from the longitudinal axes, which extend substantially equidistant laterally inwardly and form thin and pliable portions which are readily bendable upwardly and downwardly to permit ease of release from a slotted track of a web turn-up system. Such pliable portions may have a plurality of creases extending laterally thereacross for providing a serrated surface to enhance cutting of a paper web in a web turn-up system. The core may be thicker along the longitudinal axis. The multiple creases of the core material provides an increase in the tear resistance of the paperband. The element may be twisted generally about its axis prior to being enveloped by the covering member. The element may be shredded into ribbons along its axis prior to being covered by the covering member. The shredding of inner member into a plurality of elements provides an increase in the tear resistance of the paperband. The ribbons would be adhesively bonded together and to the covering member. Such adhesive bonding of the shredded inner member to each other and to the covering member enhances the overall strength of the paperband.

Additional aspects are found in the core being formed of paper, as well as the covering member. The element may be convoluted along the axis prior to being covered by the covering member. The core may include at least another element that is convoluted along its axis, with adhesive attaching the elements together. The core may include a plurality of other elements stacked on each other and shredded into ribbons with the ribbons adhered together prior to, or while being covered. The adhesive means is preferably water-soluble and biodegradable, as well as the bonding means. The core may be formed in whole or part of synthetic material, as well as the covering member. The element may be longitudinally scored or perforated adjacent its respective edges prior to being covered by the covering member causing the element to be bendable therealong, allowing for a more random orientation of the core material.

Even further aspects are to be found in a roll of paperband for use in paper web cutting and turn-up systems or for use in bailing including an elongate core having a longitudinal axis and a plurality of elongate elements disposed non-uniformly throughout and adhesively connected together with air spaces throughout and an elongate covering member having a central axis and thinner than and folded about the core with overlapping side portions space form and substantially parallel to the central axis. The covering member having a generally smooth outer surface extending along the core and adhesive means attaches the overlapping side portions together and bonds the core to the covering member. The adhesive means may be dispersed on the outer surface of the covering member so that the band is usable as a strapping paperband and to enable the band to adhere to itself when the adhesive is activated by heat and/or moisture and overlapped and pressed together.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view of a paperband in accordance with one embodiment of the present invention;

FIG. 2 is a perspective view of a second embodiment of the paperband shown in FIG. 1 wherein the core is flattened into a generally cross-sectional shape;

FIG. 2A is a perspective view of a roll of paperband as shown in FIG. 2;

FIG. 3 is a perspective view of a third embodiment of the paperband shown in FIG. 2 wherein the paperband includes a bulging medial cavity and serrated outer side edge portions;

FIG. 4 is a perspective view of a fourth embodiment of the paperband shown in FIG. 2 wherein the core is fabricated to produce a convoluted pattern and then collapsed into a generally rectangular flattened core;

FIG. 4A is an end elevational view of the core of FIG. 4 with a covering member wrapped therearound;

FIG. 5 is a perspective view of a fifth embodiment of the paperband shown in FIG. 2;

FIG. 6 is a perspective view of a sixth embodiment of the paperband shown in FIG. 2; and

FIG. 7 is an end elevational view of the paperband of FIG. 6.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art. Like numbers refer to like elements throughout, and prime and double prime notations are used to indicate similar elements in alternative embodiments.

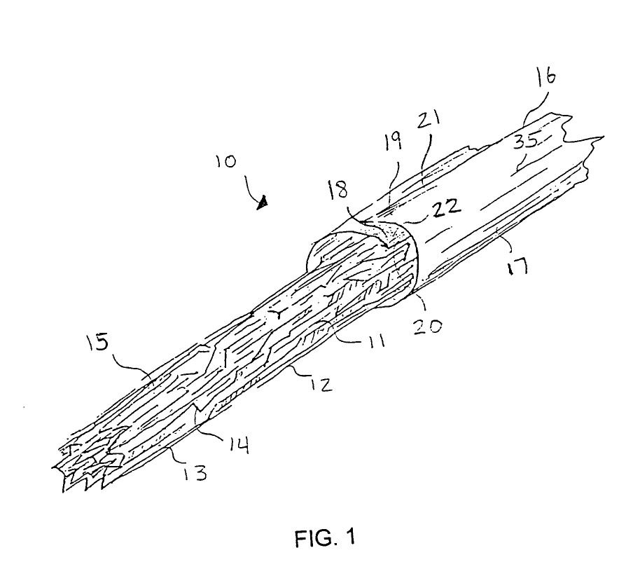

The paperband of this invention is referred to generally in FIG. 1 by reference numeral 10. Such a paperband includes an elongate core member 11 that extends along the length of the paperband 10. The core member 11 is formed from an elongate flat paper element 12 that is creased and gathered so that it has a non-planar and non-uniform outer surface 13. The element 12 has randomly spaced creases 14 along its longitudinal axis extending along its length. When the creases 14 of paper element 12 are compressed against each other, a tough outer surface 13 provides high tensile strength for the paperband to be used in spooling as shown by U.S. Pat. No. 5,954,290, or bailing as shown in U.S. Pat. No. 5,560,180.

An adhesive 15 is sprayed on the elongate element 12 to cover its outer surface 13 and is dispersed in some of the creases and will ultimately stiffen same and increase the tensile strength of the paperband. The adhesive 15 may be a conventional adhesive, such as PVA, as readily known in the paper industry and is preferably water-soluble so that it can be recycled during pulping operations. The adhesive may also be biodegradable for not damaging the environment should the paperband not be recycled.

Element 12 also could be twisted or rotated about its respective longitudinal axis for providing additional tensile strength. Thus, as element 12 is twisted, it is more tightly wrapped about its axis to provide a stiffer core 11. Such a stiffer core 11 assists in providing better cutting performance during spooling operations and bailing operations. Of course, the elements 12 may be formed from varying combinations of engineered materials to create a multiplicity of tensile and torsion strengths.

A covering member 16 is folded about the core 11 and is bonded thereto by the adhesive 15, which is preferably applied uniformly along the core 11 of the paperband 10. The outer surface 17 of the covering member 16 is generally smooth and planar but is sufficiently thin for allowing the covering member 16 to conform to the contoured cross-sectional shape of the element 12. Accordingly, the covering member 16 maintains substantially continuous contact around the core 11 and forms a substantially rectangular or cylindrical cross-sectional shape thereabout when the paperband 10 and adhesive dry.

The covering member 16 includes overlapping side portions 18, 19 oppositely spaced from its longitudinal axis and extending parallel thereto along the length of the paperband 10. The overlapping side edge portions 18, 19 extend equidistantly and inwardly from sides 20, 21, respectively, and overlap for bonding together. Such overlapping side portions 18, 19 are preferably bonded by adhesive 22 which may be the same type of adhesive as adhesive 15 previously described. The bonding of the overlapping side portions 18, 19 envelopes the core and prevents same from separating during use of the paperband in normal operating conditions.

During the gathering process or immediately following this process, the core 11 can be sprayed, coated or otherwise treated, in a manner well-known in the art, with a water-soluble adhesive in order to enhance the rigidity of the core and the resultant paperband 10 in a fixed geometry. Further, the paperband 10 may be coated with specialty chemicals for providing the paperband with engineered properties such as fire retardant and water repellent properties, as well known in the art.

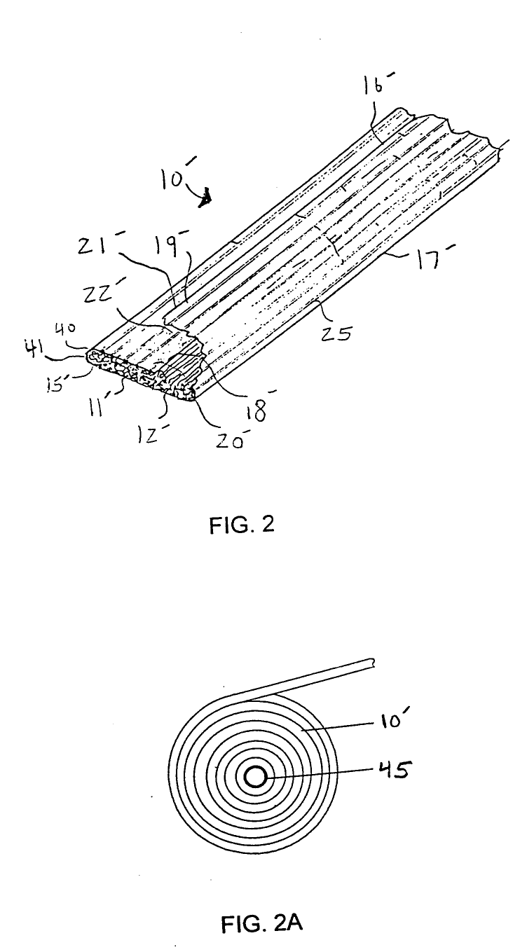

Now referring to FIGS. 2 and 2A, an alternate embodiment of the present invention is shown wherein a roll of paperband 10′ is wrapped about a central element 45, as well known in the art. The paperband 10′ includes a core 11′ that preferably includes at least another one of the elements 12′ extending along the length thereof. In particular, the paperband 10′ may include a plurality of elements 12′ coated with adhesive 15′ for bonding such elements 12′ to each other and for providing stiffness thereto. Such elements are positioned to form side-by-side rows 40 and 41 and may be individually twisted about their respective longitudinal axis. Of course, the core 11′ may include various amounts of element 12′ and should not be limited to the embodiment 10′ as shown in FIG. 2.

Similar to the previous embodiment shown in FIG. 1, the covering member 16′ includes overlapping side portions 18′, 19′ oppositely spaced from a longitudinal axis and extending parallel thereto along the length of the paperband 10′. The overlapping side portions 18′, 19′ extend equidistantly and inwardly from sides 20′, 21′, respectively and overlap each other for bonding together. Such overlapping side portions 18′, 19′ are preferably bonded together by adhesive 22′, which may be the same as adhesive 15.

Of course, the embodiment of FIG. 2 could be formed from the embodiment of FIG. 1 by passing the paperband 10 through a pair of rollers (not shown) prior to full curing or hardening of the adhesive in the core member 12′, as would occur to persons skilled in the art. Such a feature of the paperband 10′ helps reduce markings formed on a paper web (not shown), which are normally produced by non-compressible or non-deformable paperbands. Also, such a compressible paperband helps reduce crossover when traveling through a nip in turn-up applications, as readily known in the art. The compressible characteristics of the paperband 10′ allow it to have a multiplicity of slenderness ratios (width divided by thickness) for providing various stiffness properties. The covering member 16′ may also include a plurality of creases 25 extending longitudinally along its length for preventing crimping thereof during operating conditions.

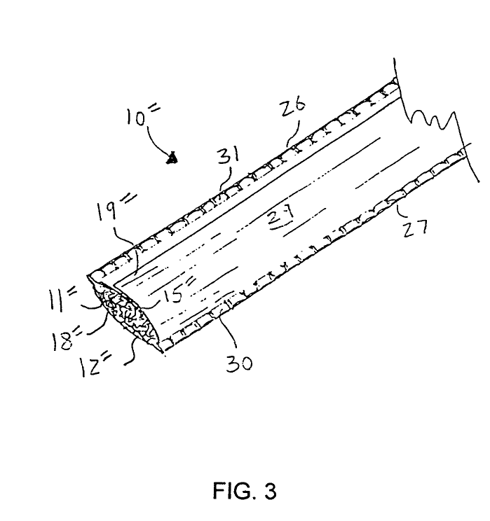

Now referring to FIG. 3, yet another embodiment of the present invention is shown wherein a paperband 10″ includes outer side edge portions 30, 31 and a cavity 29 disposed between the outer side edge portions 30, 31. Both the cavity 29 and outer side edge portions 30, 31 extend along the length of the paperband 10″ with the center of the cavity 29 being aligned along the longitudinal axis of the paperband 10″ and thereby causing to bulge therealong, for reasons explained hereinbelow.

The cavity 29 envelops the core 11″ including one or a plurality of elements 12″ disposed adjacent to each other along their respective lengths. Such elements 12″ may randomly be placed in a non-uniform pattern next to each other so that the cavity 29 will bulge at the center thereof. Again, such paperband 10″ may be formed by passing it through a pair of opposed rollers (not shown) having a slight depression in each surface thereof to produce the paperband 10″. The covering member 16″ overlaps at its side portions 18″, 19″, similar to the previous embodiments, and are bonded to each by an adhesive 22″. The elements 12″ may also be twisted about the respective longitudinal axis and include adhesive 15″ thereon for bonding to each other.

The outer side edge portions 30, 31 are preferably thin and pliable and extend equidistantly inward from the outer side edges of the paperband 10″. Such outer side edge portions 30, 31 extend substantially parallel to the longitudinal axis and along the length of the paperband and preferably include creases 26, 27 extending laterally thereacross for providing a serrated edge and for enhancing the cutting performance of the paperband 10″ during spooling operations. Such creases 26, 27 may be substantially equally spaced apart or selectively disposed along the length of the outer side edge portions 30, 31 and preferably do not penetrate through the surfaces thereof. Such creases 26, 27 may also be provided by the same rollers (not shown) mentioned hereinabove to form a bulge along the mid-portion of the paperband or can be provided by two opposing pairs of spaced rollers positioned along the respective edges of the paperband.

The above-mentioned embodiments of the present invention are preferably formed from repulpable materials such as paper or conventional synthetic materials known in the art. The materials selected may be of various physical and/or chemical properties such as tensile strength, wet strength, extensibility, etc., to allow for maximizing the band for the intended application and use required. All adhesives are preferably water-soluble and/or biodegradable so that they may be recycled during repulping operations. The thickness of the paper used to form the covering member and the core elements may vary so that the thickness of the covering member is preferably thinner than the thickness of the resulting core elements.

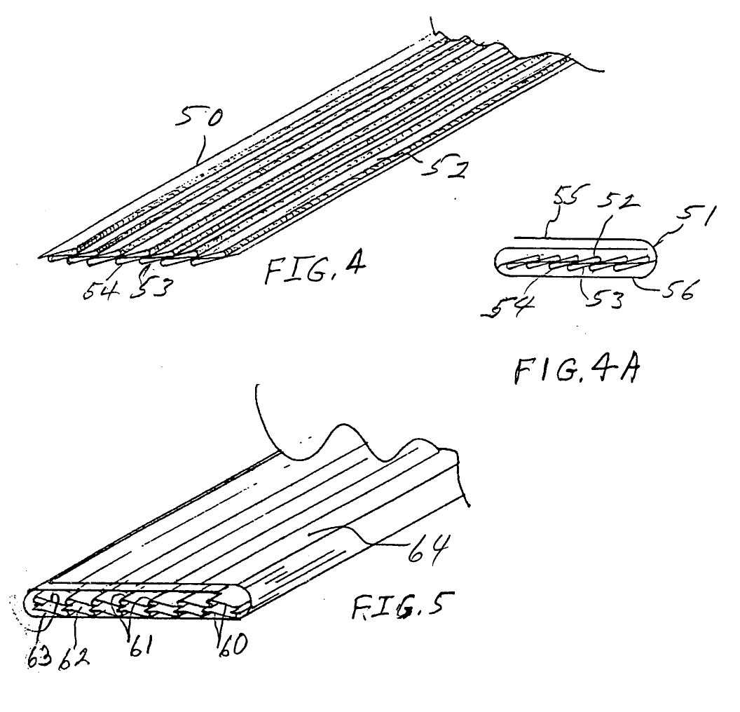

Now referring to FIG. 4, another embodiment of the present invention is depicted wherein the inner core 50 that extends the entire length of the paperband 51 is shown as being formed of an elongate flat paper element that has non-planar outer surfaces 52 and 53 that are convoluted along its entire length. The convolutions 54 are compressed together and a tough outer layer or covering 55 is adhered to the core 50 and to itself. An adhesive is applied to the inner core 50 to stiffen and create a matrix with core 50 of the band 51 and be a conventional water-soluble PVA adhesive and can be biodegradable. The outer surface 56 of the band 51 can also be coated with a water-soluble adhesive so that the band 51 may bond to itself when used in a bale strapping operations as bands had been commonly used.

As previously discussed the inner core 50 and the outer covering 55 may be of various materials to secure appropriate physical properties having a multiplicity of attributes, such as tensile strength, stiffness, compressibility of the band between its upper and lower surfaces can be achieved.

FIG. 5 depicts another embodiment with multiple layers 60 of folds or creases 61 extending longitudinally and forming core 62. These layers 60 are convoluted along their lengths and are collapsed and adhered to each other, as previously explained above, to form a non-uniform outer surface 63 to core 62. The covering 64 is wrapped around core 62 and is adhered thereto and to itself as previously described.

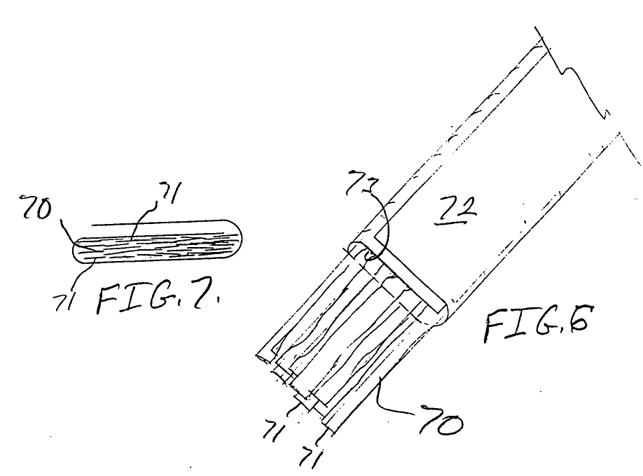

FIGS. 6 and 7 set forth another embodiment of this invention wherein the core 70 is formed from a plurality of cut ribbons of paper 71, substantially similar to that produced in the common non-crosscut paper shredding machines, and gathered to form the core 70. The ribbons of paper would be sprayed or dipped into liquid PVA as heretobefore described, and wrapped with a covering 72 and coated thereabout with adhesive. This embodiment would have advantages over the various folded embodiments by being less susceptible to perpetuation of a cross tear, having greater ability to twist, as when exiting a track beneath a paper web severing the web and transferring the web onto an empty spool. Also a more evenly filled cavity 73 may be accomplished by this embodiment of the invention.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

1. A roll of paperband adaptable for use in paper web cutting and turn-up systems or for use in bailing, said paperband comprising:
an elongate core including an elongate element having a longitudinal axis with a plurality of longitudinal creases disposed throughout same to form said core with a non-uniform and non-planar outer surface;
an elongate covering member folded about said core, said covering member including a generally smooth outer surface extending along a length of said core, said covering member having a central long axis and side edge portions spaced from and substantially parallel to said central axis with one said side edge portion overlapping another said side edge portion, adhesive means for attaching said overlapping side edge portions together; and
bonding means for attaching said core to said covering member.

2. The roll of paperband of claim 1, wherein said plurality of longitudinal creases define a plurality of randomly non-uniform fold angles relative to a plane of said core, said plurality of fold angles providing differing spatial dimensions therebetween.

3. The roll of paperband of claim 1, wherein said element and said covering member are deformable for allowing said paperband to be formed into predetermined shapes.

4. The roll of paperband of claim 1, wherein said element and said covering member are deformable for allowing said paperband to be formed into a generally rectangular cross-sectional shape.

5. The roll of paperband of claim 1, wherein said core includes at least another element substantially similar to said element disposed side-by-side and substantially parallel to each other along respective said longitudinal axis.

6. The roll of paperband of claim 1, wherein said paperband includes elongate outer edge portions spaced from said longitudinal axis, said elongate outer edge portions extending substantially equidistant laterally inwardly and forming thin and pliable portions, said thin and pliable portions being readily bendable upwardly and downwardly to permit ease of release from a slotted track of a web turn-up system.

7. The roll of paperband of claim 6, wherein said thin and pliable portions include a plurality of creases extending laterally thereacross for providing a serrated surface to enhance cutting of a paper web in a web turn-up system.

8. The roll of paperband of claim 1, wherein said covering member includes an upper and a lower portion with said core being housed therebetween, said core being thickest along said longitudinal axis.

9. The roll of paperband of claim 1, further including a plurality of longitudinal creases extending along said paperband covering member for enhancing bending of said paperband upwardly and downwardly along its length and adjacent its edges.

10. The roll of paperband of claim 1, wherein said element is twisted generally about its longitudinal axis prior to being enveloped by said covering member.

11. The roll of paperband of claim 1 wherein said element is shredded into ribbons along said axis prior to being covered by said covering member.

12. The roll of paperband of claim 11 wherein said bonding means attaches said ribbons together.

13. The roll of paperband of claim 5, wherein said bonding means includes an adhesive for attaching said core elements to each other.

14. The roll of paperband of claim 5, wherein said core elements are randomly positioned adjacent to each other for providing a thicker mid-portion.

15. The roll of paperband of claim 1, wherein said core is formed of paper.

16. The roll of paperband of claim 15, wherein said covering member is formed of paper.

17. The roll of paperband of claim 1 wherein said element is convoluted along said axis prior to being covered by said covering member.

18. The roll of paperband of claim 17 wherein said core includes at least another element that is convoluted along its said axis, and said bonding means attaches said element and at least another element together.

19. The roll of paperband of claim 1 wherein said core includes a plurality of other elements stacked on each other and shredded into ribbons, said bonding means attaching said ribbons together prior to being covered by said covering member.

20. The roll of paperband of claim 1, wherein said adhesive means is water-soluble.

21. The roll of paperband of claim 1, wherein said adhesive means is biodegradable.

22. The roll of paperband of claim 1, wherein said bonding means is water-soluble and biodegradable.

23. The roll of paperband of claim 1, wherein said core is formed of synthetic material.

24. The roll of paperband of claim 17, wherein said covering member is formed of synthetic material.

25. The roll of paperband of claim 1 wherein said element is longitudinally scored or perforated adjacent its respective edges prior to being covered by said covering member causing said element to be bendable therealong.

26. A roll of paperband for use in paper web cutting and turn-up systems or for use in bailing, said paperband comprising:
an elongate core having a longitudinal axis and a plurality of side-by-side elongate elements, each said element including a plurality of longitudinal creases disposed throughout same so that said elements have non-uniform and non-planar outer surfaces, respectively;
an elongate covering member thinner than and folded about said core, said covering member having a central long axis and overlapping side portions spaced from and substantially parallel to said central axis, said covering member including a generally smooth outer surface extending along a length of said core; and
adhesive means for attaching said overlapping side portions together and for bonding said core to said covering member.

27. The roll of paperband of claim 26, wherein said paperband has a generally rectangular cross-sectional shape.

28. The roll of paperband of claim 27, wherein said paperband includes opposed elongate edges spaced from said central long axis, said elongate edges extending substantially equidistant laterally inwardly and forming pliable elongate portions, said pliable portions being readily bendable upwardly and downwardly to permit ease of release from a slotted track of a web turn-up system.

29. The roll of paperband of claim 28, wherein said pliable portions include a plurality of creases extending laterally thereacross for providing a serrated surface to enhance cutting of a paper web in a web turn-up system.

30. The roll of paperband of claim 26, wherein said adhesive means is water-soluble and biodegradable.

31. The roll of paperband of claim 30, wherein said core and said covering member are formed of paper.

32. The roll of paperband of claim 26, wherein said adhesive means is dispersed within said creases of each said element.

33. The roll of paperband of claim 26, wherein said adhesive means is dispersed on said outer surface of said covering member to permit activation thereof for attaching a cut portion of said paperband to itself.

34. A roll of paperband for use in paper web cutting and turn-up systems or for use in bailing, said paperband comprising:
an elongate core having a longitudinal axis and a plurality of elongate elements disposed non-uniformly throughout and adhesively connected together with air spaces throughout;
an elongate covering member thinner than and folded about said core, said covering member having a central axis parallel to said axis and overlapping side portions spaced from and substantially parallel to said central axis, said covering member including a generally smooth outer surface extending along a length of said core; and
adhesive means for attaching said overlapping side portions together and for bonding said core to said covering member.

35. The roll of paperband of claim 34, wherein said adhesive means is dispersed on said outer surface of said covering member.

36. The roll of paperband of claim 34, wherein said paperband has a generally rectangular cross-sectional shape.

37. The roll of paperband of claim 36, wherein said paperband includes opposed elongate edges spaced from said central axis, said elongate edges extending substantially equidistant laterally inwardly and forming pliable elongate portions, said pliable portions being readily bendable upwardly and downwardly to permit ease of release from a slotted track of a web turn-up system.

38. The roll of paperband of claim 37, wherein said pliable portions include a plurality of creases extending laterally thereacross for providing a serrated surface to enhance cutting of a paper web in a web turn-up system, and providing for a smooth, uniform radius when said band is wound around an empty spool of a web turn-up system.

39. The roll of paperband of claim 34, wherein said adhesive means is water-soluble and biodegradable.

40. The roll of paperband of claim 39, wherein said core and said covering member are formed of paper.
